(19) United States
(12) Patent Application Publication
(10) Pub. No.: US 2002/0174093 A1
(43) Pub. Date: Nov. 21, 2002

(54) Method of identifying and analyzing business processes from workflow audit logs

(76) Inventors: Fabio Casati, Palo Alto, CA (US); Ming-Chien Shan, Saratoga, CA (US); Li-Jie Jin, Mountain View, CA (US); Umeshwar Dayal, Saratoga, CA (US); Daniela Grigori, Nancy, CA (US); Angela Bonifati, Milano (IT)

Correspondence Address: HEWLETT-PACKARD COMPANY, Intellectual Property Administration, P.O. Box 272400, Fort Collins, CO, 80527-2400, US

(21) Appl. No.: 09/860,230

(22) Filed: May 17, 2001

(51) Int. Cl. G06F 7/00

(52) U.S. Cl. 707/1

(57) ABSTRACT

A method of identifying and analyzing business processes includes the step of populating a data warehouse database with data from a plurality of sources including an audit log. The audit log stores information from a plurality of instantiations of a defined process. The data is then analyzed to predict an outcome of a subsequent instance of the process. Data mining techniques such as pattern recognition are applied to the data warehouse data to identify specific patterns of execution. Once the patterns have been identified, the outcome of a subsequent instance of the process can be predicted at nodes other than just the start node. The probability of completion information can be used to modify resource assignments, execution paths, process definitions, activity priority, or resource assignment criteria in subsequent invocations of the defined process.

### FIELD OF THE INVENTION

This invention relates to the field of business processes analysis, prediction, and optimization using computer generated workflow audit logs.

### BACKGROUND OF THE INVENTION

Workflow management systems are used to monitor an organization's various administrative and production processes. These processes are defined in terms of activities, resources, and input and output process data. For a given process instance, the workflow management system might record information about the activities performed, when these activities are performed, time used to perform the activity, the identity of any resources involved in the activities, the outcome, and other data related to execution of the activities. This information is recorded as log data to permit subsequent reporting. Through various reporting tools the information is summarized and provided to analysts, workflow design, system administrator or other entities.

Typical workflow management systems permit users to query the execution state of a running process, report the number of process instances started or completed within a given time period, or compute simple statistics about groups of instances of a given process.

One disadvantage of traditional workflow management systems is a limited ability to address individual instance information both individually and relative to a collection or aggregate of instances.

For example, some workflow management systems place specific codes in data fields in the event of failure (e.g., “Jan. 1, 1970”). This data, however, invalidates aggregate calculations such as average activity execution time. In addition, queries that ensure proper calculation of aggregate values can be exceedingly complex to write. For example, writing queries that determine, for each fiscal quarter, the number of instances started and completed, the failure rate, and other quality/performance merits is difficult, time-consuming, and requires considerable database and workflow skills. As a result, traditional workflow management systems only offer very limited analysis functionality. In addition, they cannot make predictions about specific instances of a process or tune the process to improve process execution quality.

### SUMMARY OF THE INVENTION

In view of limitations of known systems and methods, a method of identifying and analyzing business processes includes the step of populating a data warehouse database with data from a plurality of sources including an audit log, wherein the audit log stores information from a plurality of instantiations of a defined process. The data is then analyzed to predict an outcome of a subsequent instance of the process. Data mining techniques are applied to the data warehouse data to identify specific patterns of execution. Once the patterns have been identified, the outcome of a subsequent instance of the process can be predicted at nodes other than just the start node. The probability of completion information can be used to modify resource assignments in subsequent invocations of the defined process.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of a product manufacturing process.

FIG. 2 illustrates one embodiment of an expense approval process.

FIG. 3 illustrates a process definition and event logging system.

FIG. 4 illustrates types of entities used for process definition.

FIG. 5 illustrates a method of generating a data warehouse for one or more processes.

FIG. 6 illustrates creation of a data warehouse for business processes.

FIG. 7 illustrates one method of using workflow management audit logs to analyze and model business processes in order to predict and modify future behavior.

### DETAILED DESCRIPTION

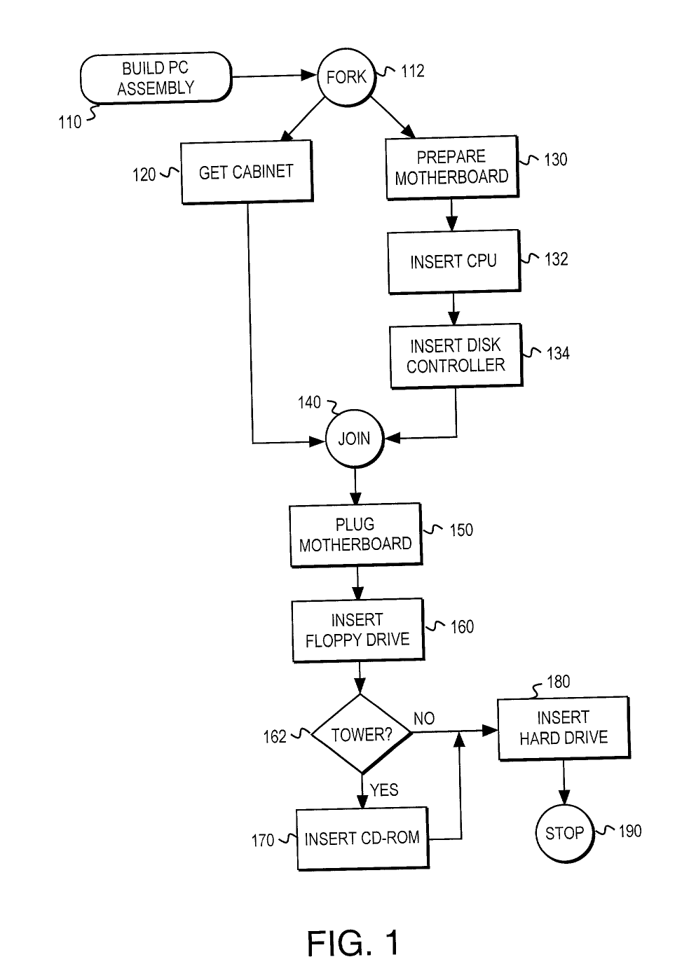

Processes may be modeled as a directed graph having at least four types of nodes including work nodes, route nodes, start nodes, and completion nodes. A process definition can be instantiated several times and multiple instances may be concurrently active. Activity executions can access and modify data included in a case packet. Each process instance has a local copy of the case packet. FIG. 1 illustrates one embodiment of a process definition.

Node 110 represents a start node. The start node defines the entry point to the process. Each hierarchical definition level has at least one start node.

Nodes 120, 130, and 132 are examples of work nodes. A work node represents the invocation of a service or activity. Each work node is associated with a service description that defines the logic for selecting a resource or resource group to be invoked for executing the work. The service definition also identifies the case packet data items to be passed to the resource upon invocation (e.g., execution parameters or input data) and to be received from the resource upon completion of the work (e.g., status values, output data). Several work nodes can be associated to the same service description.

A service may be composed of a single atomic activity to be executed by a human or automated resource. Alternatively, a directed graph composed of a combination of work nodes and decisions may be referred to as a service. In this case, a service is analogous to a procedure or subroutine in an application program. The term “service” permits a convenient reference by name to a specific graph of activities and decisions without re-iterating these individual components each time. For convenience sake, the series of activities may be invoked by referring to the service instead of the component sequence of tasks each time. The introduction of services enables a single definition to be re-used multiple times within the same process or in multiple processes. Thus a service may be used multiple times by a given process or by more than one process.

Node 140 represents a route or decision node. Route nodes are decision points that control the execution flow among nodes based on a routing rule.

Nodes 112 and 140 also control execution flow. Node 112 represents a fork in the execution flow. The branches may continue concurrently. Node 120 represents a joining of branches into a single flow. No further flow execution occurs until each branch preceding the join has completed. Join nodes and fork nodes are really special types of decision nodes.

Node 190 is a completion node. A process may have more than one completion node at a given hierarchical level.

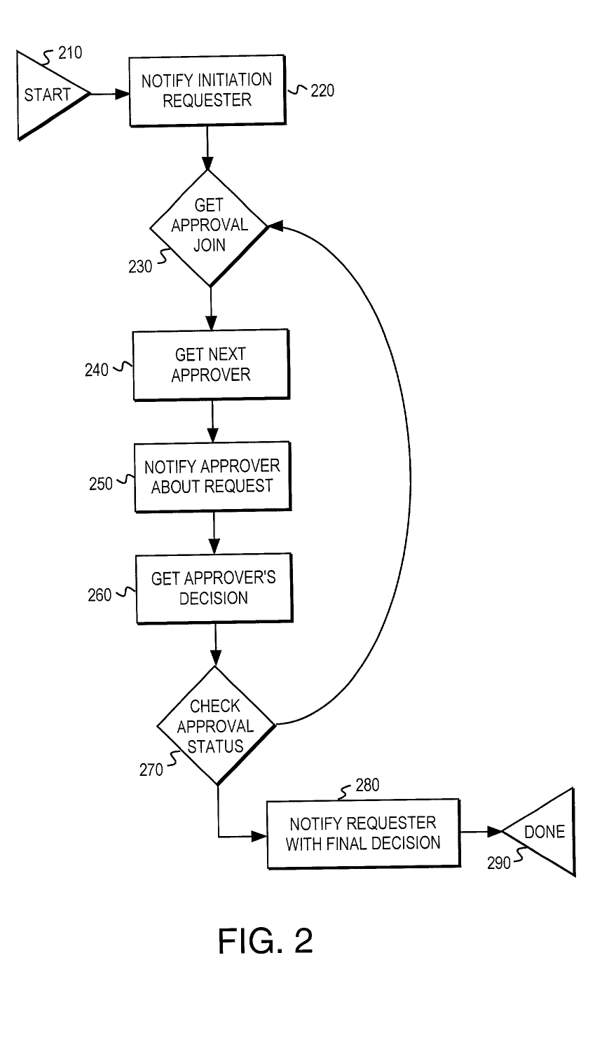

FIG. 2 illustrates a model of a business process for approving an expense. The process begins in start node 210 with the requester. The case packet data for the process might include the identity of the requester, the expense amount, the reasons, and the names of the individuals that should evaluate the request. Once the process is initiated, the requester is notified in work node 220.

Work node 220 may invoke another service for notification. For example, notification might be performed by the service send_email. Upon invocation of the service, an email is sent to the requester notifying him that the process has begun. The process loops among the list of individuals until either all of them approves the expense or one of them rejects the expense (nodes 230-270). (Join 230 is an OR join that fires whenever any input fires. The result is provided to the requester as illustrated by work node 280 before completion of the process at completion node 290.

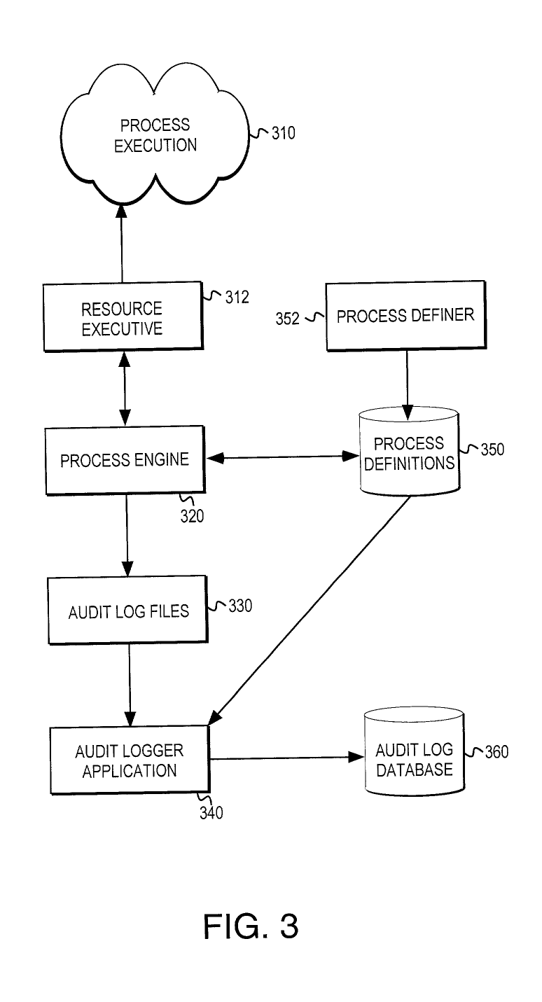

A workflow management system may be used to log execution data for different instantiations of a defined process. FIG. 3 illustrates one embodiment of the use of a workflow engine to generate audit logs containing status information about different instantiations of one or more defined processes. Elements 352, 350, 312, 320, 330 and 340 may be collectively referred to as a workflow engine which generates an audit log database 360 containing information about process execution 310.

Process definer 352 defines processes as a collection of nodes, services, and input and output parameters. These process definitions are stored in database 350. The database may contain, for example, a process definition including a start node, a completion node, work nodes, route nodes, and services that the process is composed of. The process definition will also indicate how the nodes are connected to each other. The process definer 352 is used to specify the process definitions for the process definitions database 350.

The process engine 320 executes processes by scheduling nodes to be activated. When a work node is activated, the process engine retrieves the associated service definition and resource assignment rule. The resource rule is communicated to resource executive 312. The resource executive identifies the specific resources that should execute the service.

For example, the resource executive 312 selects specific resources such as a specific vendor, a specific employee, a specific piece of equipment, etc. The process engine controls the execution of processes. When executing a process, the process engine steps through the process definition to determine which activity should be performed next, and uses the resource executive 312 to assign a resource (or resources) to the activity. The process engine 320 then sends an activity along with the data required to perform the activity to the resource identified by the resource executive 312. When the activity is completed, the process engine refers to the process definition to determine what happens next.

In one embodiment, the process execution information is written directly to an audit log database 360. Alternatively, the process execution information is first written to audit log files 330 which serve as a buffer so that database performance does not adversely impact the recording function. The audit logger application 340 receives process definition information from database 350 and execution status information from the audit log files 330. Audit logger application 340 stores at least a subset of the information in the audit log files into audit log database 360. The user may choose to record different levels of information depending upon the purpose of the audit log. In one embodiment, databases 350 and 360 support an Open Database Connectivity (ODBC) application programming interface. The use of a buffer prevents database performance from impacting process execution. In particular, events that trigger a logging operation are not lost in the event the audit logger is unable to keep up with the process engine. The use of a buffer also enables updates to database 360 to be organized for efficiency rather than being driven directly by events as they occur in the executing process.

The audit logger 340 uses the events recorded in the audit log files 330 and the definitions from the process engine database 350 to generate various statistics about process events or to log information on individual processes. The information generated by the audit logger application 340 is stored in the audit logger database 360. The amount of information logged for each process instance varies depending upon the level of logging defined for the process.

The audit log database provides information regarding particular instances of a process. For example, a particular instance may be identified by a unique identifier, the start time and the completion time of the process instance. Node instance information describes an element or step such as a work node or a route node in a process definition. Exemplary node information includes a unique node identifier, the time the instance of the node was created, and the time the instance of the node was completed. Activity instance information describes the activity or set of activities generated by a work node. The type of activity, time the activity instance was created, and the time the activity instance was completed are examples of information that may be logged for activities.

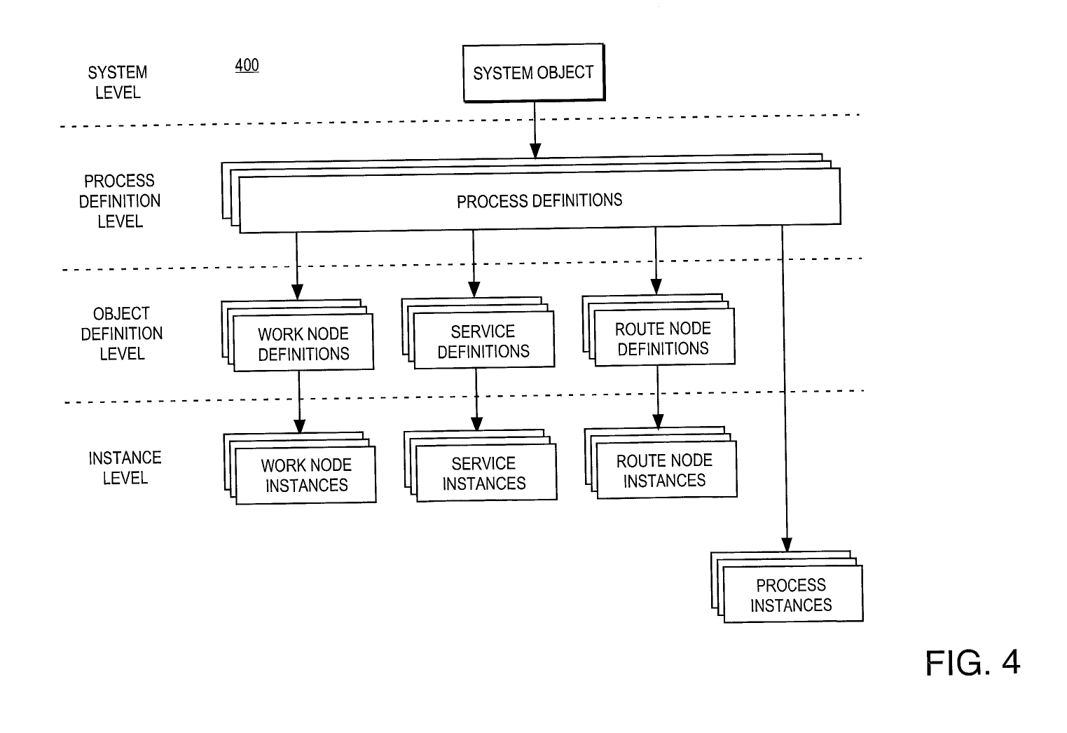

FIG. 4 illustrates a hierarchy 400 for entities about which information may be reported from audit log database 360. With respect to processes, the user may select to have only the identity of defined processes logged (i.e., process definition level). If more detail is required, the user may elect to have work node definitions, service definitions, and route node definitions for each defined process logged (i.e., object definition level). If still more detail is desired, information about each instantiations of work nodes, services, and route nodes may be recorded (i.e., instance level).

Depending upon the level of reporting desired, the information stored within the audit log database may include process identity, start date/time, completion date/time, start and completion date/time for each work node, specific resource assignments for work nodes, input and output data or parameters for each work node, etc.

Data mining techniques such as pattern matching and classification are then applied to the contents of the data warehouse including the audit logs to identify patterns occurring during process execution. These patterns may be used to predict process execution quality, workload on the system and on the resource, and more. For example, the patterns may be used to predict the completion of subsequent instances of the process from nodes other than a start node. Data mining uses pattern recognition, statistical, and other mathematical techniques to identify correlations, patterns, and trends. Large amounts of data may be selected, explored, and modeled with pattern matchers, for example, to identify specific conditions under which exceptions or significant changes in performance occur.

Analyzing the workflow warehouse with data mining techniques can reveal that a specific resource fails or is incapable of meeting process requirements under certain conditions which are not otherwise obvious to the observer and may in fact be inter-related with conditions seemingly unrelated to the resource. Generally, these techniques may identify conditions for which process execution quality departs from typical or average quality or is incapable of meeting a service level agreement. The user must select a sufficient level of reporting detail to ensure that data directly related to the cause or correlated with the cause of these differences in performance are stored in the audit logs.

For example, if one machine is not performing properly, the audit log database and the warehouse must have resource assignment information to identify the problem (causation). If throughput improves at different times of day or on different days of the week, for example, due to the availability of better performing resources, then recordation of the start and stop times rather than just elapsed time will at least enable the discovery of information highly correlated with the cause even if specific resource assignments are not recorded. The pattern information enables analyzing the process or processes so that predictions may be made with respect to subsequent process instantiations that match the pattern. The pattern information enables the derivation of rules to describe the behavior. The rules, in turn, are the basis for subsequent analysis and the predictive models. The rules may be examined to determine the cause or at least identify events highly correlated with the cause.

In order to identify patterns and make predictions, specific process instance information as well as aggregate information about the status of process instance executions are required. This information is collected and stored in a data warehouse for analysis along with other data necessary for generating the type of information and in a format desired by the user.

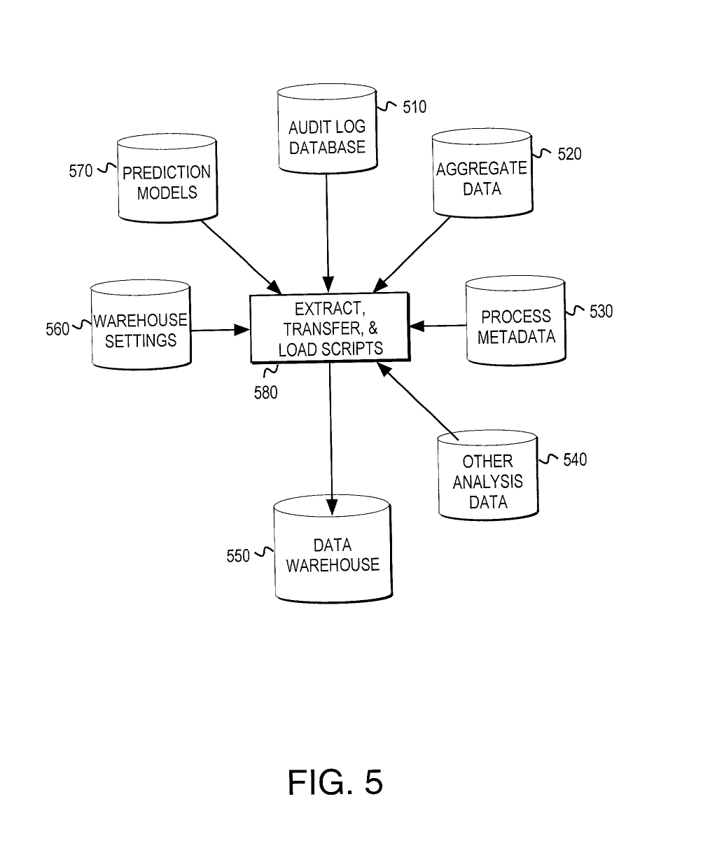

FIG. 5 illustrates the types of data that may be used for analysis. The audit log database 510, aggregate data 520, process metadata 530 (e.g., process properties including cost, priority, etc.), prediction models 570, warehouse settings 560, and other analysis data 540 are loaded into data warehouse 550. The data warehouse may also contain the definitions of processes, nodes, or resources that can be associated with behavior of interest. Extract, transfer, and load scripts 580 may be used to obtain the audit log 510, warehouse setting 560, and process metadata 530 information for the data warehouse.

The audit log database 510 is generated by the workflow engine. The aggregate database may be generated by other applications such as the data mining application. The aggregate database may include averages, counts, maximum, minimum, etc. values for various monitored process execution data. The aggregate data is calculated from historical execution data and continuously updated as subsequent instances of the process are invoked.

The prediction models are generated and updated by the data mining process. The warehouse settings and other analysis data are provided by the user. The warehouse settings typically includes control settings for the data warehouse and other information related to maintenance of the data warehouse. The other analysis data may include trend lines or models that the user desires to compare the process execution performance with that is distinct from the aggregate data.

In one embodiment, the data warehouse provides a structured query language (SQL) interface for accessing and maintaining the data. Thus standard commercial reporting tools can still be used to generate reports.

Some of the extract, transfer, and load (ETL) scripts are tailored for the specifics of the source database. Thus, for example, in the presence of audit logs produce by workflow management applications from different vendors, the ETL scripts must include scripts tailored to accommodate the vendor-specific source record format and idiosyncrasies with respect to data values. The ETL scripts must extract the data from the audit logs. The extracted data must then be normalized. If, for example, start and stop times are recorded in different formats for audit logs from different vendors, the time values are converted to a common format. The data must also be “cleaned” to ensure that vendor-specific audit mechanisms do not impair the ability to properly calculate aggregate values. In particular, the use of default values in fields used for aggregate calculations are avoided.

For example, elapsed execution times may be pre-calculated for storage by the audit logger. Alternatively, elapsed execution times may subsequently calculated by subtracting the start times from the stop times. The use of default date/time values for stop time in the event of process exceptions would result in an invalid elapsed time, which in turn would adversely affect aggregate calculations (e.g., averages). The ETL script for a specific audit logger must be aware of vendor-specific implementations in order to properly clean the data for subsequent processing. Instead of a default date/time value, for example, a null value may be used so that aggregate elapsed time calculations would not be affected. Once the data has been cleaned and transferred into a common format from possibly different vendor formats, the data is loaded into the data warehouse.

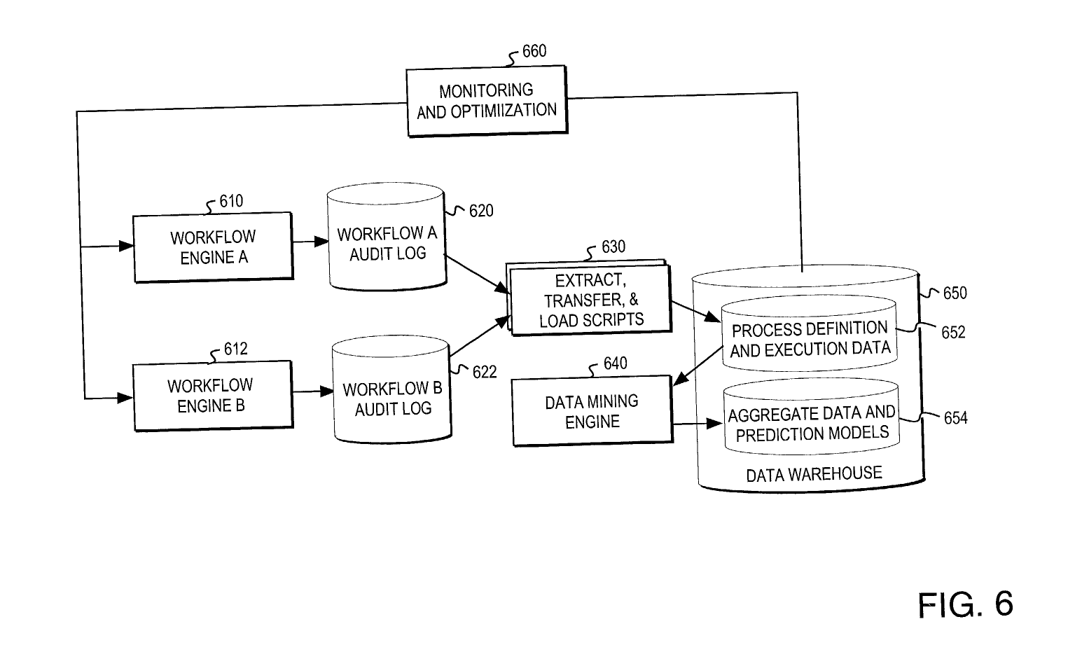

FIG. 6 illustrates the path of data flow for identifying and analyzing business processes. The method can be applied to processes being tracked by multiple workflow engines 610, 612 which may be from different vendors. Each workflow engine 610, 612 generates a corresponding audit log 620, 622. The extract, transfer, and load scripts 630 are applied to populate the data warehouse with process definition and instance execution data 652. Some of the extract, transfer, and load scripts 630 are specifically designed to accommodate their corresponding vendor-specific audit logs 620 and 622. The ETL scripts also generate some aggregate information. Other aggregate data is specified in terms of views and therefore maintained and updated by the database.

Data mining engine 640 operates on the process definition and execution data 652 to generate aggregate data and prediction models 654. Based on patterns identified from data mining analysis, the prediction models, for example, can reveal rules that can be applied to running process instances to predict their outcome, completion time, the services and resources involved in the execution, etc. The use of aggregate data alone would not otherwise take into account patterns that occur with respect to specific resource assignments.

The prediction models may then be used by monitoring and optimization block 660 to modify resource assignments for subsequent process instances and to make other optimizations by changing process and system characteristics. In one embodiment, the prediction models may be used to identify the risk of an undesirable pattern and then re-assign resource assignments to prevent realization of the undesirable pattern. Alternatively, the monitoring and optimization block 660 may update the workflow engines to re-prioritize resource assignments, modify resource assignment criteria, or modify process definitions in order to reduce the likelihood of the realization of an undesirable pattern.

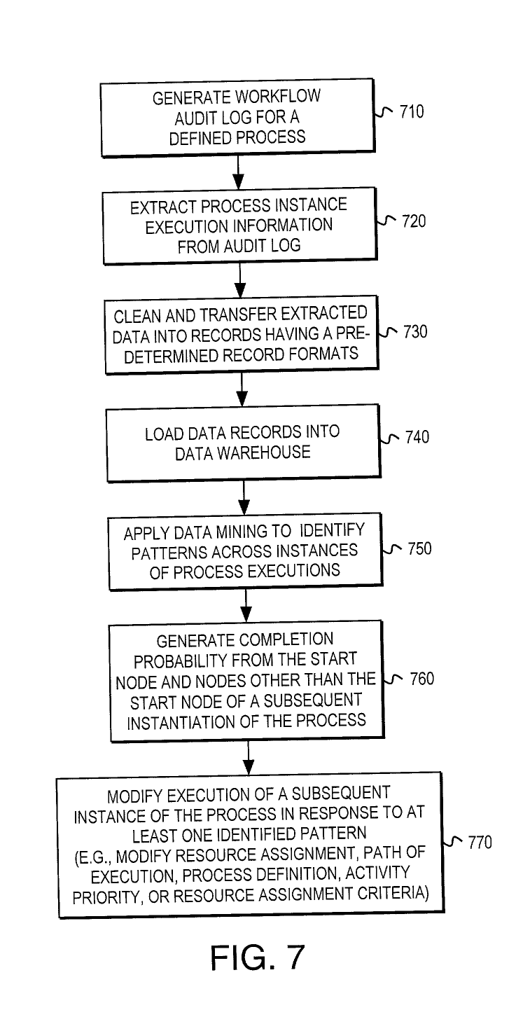

FIG. 7 illustrates one embodiment of a method for identifying and analyzing business processes from a workflow audit log. In step 710, a workflow audit log is generated for instances of execution of a defined process. In step 720, the desired process instance execution information is extracted from the audit log. The extracted data is cleaned and transferred into records with pre-determined formats in step 730. This ensures data from different vendor audit logs can be put into a common format for subsequent analysis. The data records are then loaded into the data warehouse in step 740. Steps 720-740 are handled by extract, transfer, and load scripts in one embodiment.

In step 750, data mining is applied to the data warehouse data in order to identify patterns across instances of process executions. Data mining enables 1) discovery of the actual business process followed in the organization and modifications of the defined workflows to better match these business processes; 2) understanding the performance and quality both in general or relative to other resources or with respect to the execution of specific services, nodes, or processes; 3) identifying the causes of behaviors of interest such as process execution characterized by a very high or low quality; 4) derivation of rules and prediction models that can be used to make predictions for process execution outcome, duration, invoked services, invoked resources, system load, and resource load; and 5) tracking, monitoring, and reporting of process metrics.

For example, the resources can be rated relative to other resources depending on the work they perform and when the work is performed. The prediction models may be used to predict whether a node will be activated or not and if so then how many times. Similarly, the prediction models may be used to predict the use of a resource and the load on the system and the resources. The prediction models may be used on executing process instances to modify routing rules, resource assignment, or other characteristics dynamically, for example, to improve process throughput or process execution quality. For example, the prediction models may be used to dynamically modify any of 1) a selection of resources applied to individual activities of the process; 2) a path of execution; 3) a process definition; 4) an activity priority, and 5) a resource assignment criteria for the subsequent instance of the process in response to a result of the analyzed data.

In step 760, completion probabilities from the start node and nodes other than the start node can be generated for subsequent instantiations of the process. In step 770, execution of a subsequent instance of the process is modified in response to at least one identified pattern. As discussed above, the process may be dynamically modified by performing any of the steps of modifying the resource assignment, modifying the execution path, redefining the process, changing the activity priority, or changing the resource assignment criteria.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method comprising the steps of:
a) populating a data warehouse database with data from a plurality of sources including an audit log, wherein the audit log stores information from a plurality of instantiations of a defined process;
b) analyzing the data to predict an outcome of a subsequent instance of the process.

2. The method of claim 1 further comprising the step of:
c) modifying at least one of a selection of resources applied to individual activities of the process, a path of execution, a process definition, an activity priority, and a resource assignment criteria for the subsequent instance of the process in response to a result of the analyzed data.

3. The method of claim 1 wherein step b) further comprises the step of predicting the outcome at a plurality of nodes within the defined process.

4. The method of claim 1 wherein step b) further comprises the step of:
applying a pattern matcher to the data to identify patterns of execution.

5. The method of claim 1 wherein step b) further comprises the step of:
applying data mining techniques to the data warehouse to identify patterns of execution.

6. The method of claim 1 further comprising the step of:
c) modifying a selection of resources applied to individual activities of the process in response to the predicted outcome.

7. The method of claim 1 further comprising the step of:
c) modifying a selection of an execution path within the process in response to the predicted outcome.

8. The method of claim 1 further comprising the step of:
c) modifying a priority of the process in response to the predicted outcome.

9. The method of claim 1 further comprising the step of:
c) analyzing the data to identify patterns corresponding to a cause of at least one of a selected predicted outcome and a selected actual outcome.

10. The method of claim 1 further comprising the step of:
c) analyzing the data to identify patterns corresponding to a high correlation with a cause of one of a selected predicted outcome and a selected actual outcome.

11. The method of claim 1 further comprising the step of:
c) analyzing the data to identify patterns resulting in outcomes representing a departure from an average outcome for at least one measured process metric.

12. A method comprising the steps of:
a) populating a data warehouse database with data from a plurality of sources including an audit log, wherein the audit log stores information from a plurality of instantiations of a defined process;
b) analyzing the data to identify process outcome classification rules; and
c) predicting completion probability from at least one node other than a start node of a subsequent instantiation of the defined process.

13. The method of claim 12 further comprising the step of:
d) modifying at least one of a selection of resources applied to individual activities of the process, a path of execution, a process definition, an activity priority, and a resource assignment criteria for the subsequent instantiation of the process in response to at least one of the predicted completion probabilities.

14. The method of claim 12 wherein step b) further comprises the step of predicting the completion probability at a plurality of nodes within the defined process.

15. The method of claim 12 wherein step b) further comprises the step of:
applying a pattern matcher to the data to identify patterns of execution.

16. The method of claim 12 wherein step b) further comprises the step of:
applying data mining techniques to the data warehouse to identify patterns of execution.

17. The method of claim 12 further comprising the step of:
d) modifying a selection of resources applied to individual activities of the process in response to at least one of the predicted completion probabilities.

18. The method of claim 12 further comprising the step of:
c) modifying a selection of an execution path within the process in response to at least one of the predicted completion probabilities.

19. The method of claim 12 further comprising the step of:
c) modifying a priority of the process in response to at least one of the predicted completion probabilities.

20. The method of claim 12 further comprising the step of:
c) analyzing the data to identify patterns correlated with selected completion probabilities.
